(19) United States
(12) Patent Application Publication
(10) Pub. No.: US 2008/0135525 A1
(43) Pub. Date: Jun. 12, 2008

(54) Electrical switching device

(75) Inventors: Patrick Claeys, Darmstadt (DE); Juergen Hofmann, Einhausen (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/984,300

(22) Filed: Nov. 15, 2007

(30) Foreign Application Priority Data
Nov. 16, 2006 (DE) 10 2006 054 030.1

(51) Int. Cl. H01H 9/30

(52) U.S. Cl. 218/151

(57) ABSTRACT

The invention relates to electrical switches, in particular line-protection circuit breakers or motor protection circuit breakers, with at least one contact point at which an arc occurs during a switching operation. Having a stack of arc-extinguishing plates made up of several extinguishing plates, the extinguishing plates of said stack being held together with a spacing by means of holding elements, the holding elements are made from a thermoplastic, the subsequent assembly of which is radiation cross-linked.

### RELATED APPLICATIONS

This application claims priority under 35 U.S.C. §119 to German Application No. 10 2006 054 030.1 filed in Germany on Nov. 16, 2006, the entire contents of which are hereby incorporated by reference in their entireties.

### TECHNICAL FIELD

An electrical switching device is disclosed.

### BACKGROUND INFORMATION

Electrical switches of this kind are line-protection circuit breakers, motor protection circuit breakers and the like, which serve to disconnect electrical lines, which are loaded with overcurrents of high current strength (short-circuit currents), from the supplying network in the event of a fault. For this purpose, line-protection circuit breakers have a contact point with a fixed and a moving contact piece, whereas with motor protection circuit breakers a double contact point is often provided having two fixed and two moving contact pieces, the latter being fitted to a contact bridge by means of which the two fixed contact pieces can be bridged.

When the contact points open, that is to say when the moving contact pieces are lifted from the fixed contact pieces, a switching arc, which is extinguished in an extinguishing device provided for the purpose, occurs at each contact point. The arc, which occurs immediately on switching off, commutates onto arc conducting rails and enters a stack of arc-extinguishing plates in which the arc is divided into shorter partial arcs, as a result of which a high arc voltage is produced to limit the current so that the arc extinguishes. The higher the number of plates in the arc-extinguishing stack, the larger the arc voltage becomes.

The stacks of arc-extinguishing plates generally consist of a defined number of extinguishing plates made from ferromagnetic steel, which are held spaced apart from one another by an insulating holding element or by insulating holding elements.

It is of no importance for the disclosure that the arc-extinguishing plates have entry slots designed in a particular manner.

Particle board strips, or, in the case of an elaborate embodiment, a 3-layer material combination made from a synthetic aromatic polyamide polymer and Akadur, are used as holding elements with which the arc-extinguishing plates are held spaced apart from one another.

Furthermore, there is also the possibility of coating the stack of arc-extinguishing plates itself with a plastic material, as a result of which the base of the arc is stabilised in the stack of extinguishing plates.

Furthermore, stacks of arc-extinguishing plates, which are held by means of side strips made from the above-mentioned materials, are also to be found; in addition, a so-called exhaust air mask, that is a cover with slots arranged on the rear of the stack of arc-extinguishing plates, can also be provided, and furthermore completely encased stacks of arc-extinguishing plates can also be found.

The use of particle board, in particular the type encased by a particle board film, is the most economic construction with regard to the manufacture of the arc-extinguishing chamber and assembly in a line-protection circuit breaker or a motor protection circuit breaker. On account of the inexpensive particle board material, the material costs are correspondingly low. As the individual components of the stack of extinguishing plates are very robust, the insertion and assembly of the parts can be categorised as being unproblematic. The quality of the device is also correspondingly reproducible.

In some embodiments of antechambers, which lie between the contact point and the actual stack of arc-extinguishing plates, materials are provided, which on the occurrence of the arc partially gasify due to the arc, as a result of which the gas pressure on the arc is increased and entry into the arc-extinguishing chamber is accelerated.

As particle board is not a gasifying material, the use of a stack of arc-extinguishing plates held together with particle board is limited with regard to the switch-off power and rated current range.

Systems, which are subject to high thermal loading, can resort to designs with side strip material made from Akadur and the synthetic aromatic polyamide polymer (which is marketed under the brand name “Nomex”), although this material combination of Akadur, Nomex and Akadur in the form of 3-layer strips is very cost intensive.

Furthermore, it must be stated that, with this material, the plastic strip for is manufacturing a plastic plate, which can be fitted to one or more of the arc-extinguishing plates, deforms into a sword-like shape, which makes manufacturing problematic. The joining process between the side strips and the plastic plate is likewise difficult, as the necessary forces encountered in the joining process cannot be absorbed by the unstable plastic plate. This then leads to stacks of arc-extinguishing plates sometimes finding their way into final assembly without secured plates or with inadequately secured plates.

If, in addition, the slotted cover is used on the rear side of the stack of extinguishing plates, then an additional component, which must be appropriately manufactured and fitted manually before the stack of arc-extinguishing plates can be fitted, must be processed during assembly, because such an exhaust air mask cannot be processed in a vibrator during assembly, so that in this case an intermediate manual step is necessary, which makes the stack of arc-extinguishing plates more expensive.

### SUMMARY

An electrical switching device is disclosed of the kind mentioned in the introduction with which the manufacture of the stack of arc-extinguishing plates is simplified and can also be mechanised.

According to the disclosure, this object is achieved in that the holding elements are manufactured from a thermoplastic, which is radiation cross-linked after assembly.

Radiation cross-linked thermoplastics as such are known, see PTS-Technik, PTS-Marketing, Strahlenvernetzung, May 2002 published by the company PTS (Plastic Technology Service), Hautschenmühle 3, 91587 Adelshofen. According to this, thermoplastic materials are cross-linked by means of electron beams or cobalt 60 (gamma radiation) regardless of the shaping process, wherein the cross-linking can be adjusted by means of the radiation dose. In many cases, a cross-linking booster can also be used. Certain main characteristics can be improved by means of radiation cross-linking, see stated publication, Page 4, Item 2.

As a result of this, the thermal usage limits of inexpensive standard and engineering thermoplastics, for example DE, PT, PA 6, PA 6.6, TBT, are extended, and the resistance to media highly increased. In particular, the amorphous portions of partially crystalline thermoplastics are cross-linked by means of electron beams, which leads to a change in the molecular structure and an increase in the degree of cross-linking. This results in increased resistance to distortion when exposed to heat, improved strength and creepage characteristics, and a reduced thermal expansion. The resistance to wear and the resistance to stress cracking are also significantly increased. Furthermore, a fibre-matrix adhesion and a plastic-plastic bonding strength are also improved.

Because of the radiation cross-linking, the material is no longer able to melt; the resistance to distortion guarantees a more consistent behaviour during short-circuit switch-off and, in addition, the gas pressure and therefore also the arc voltage between the individual extinguishing plates is increased due to the out-gassing of the thermoplastic.

When a so-called exhaust air mask or a complete encasing of the stack of arc-extinguishing plates is provided, cross-linked thermoplastics can also be used for this purpose in that the stack of arc-extinguishing plates is first encased with the thermoplastic and the arc-extinguishing plates fixed, and then the thermoplastic, to which an additive for increasing the radiation cross-linking has been added if necessary, is cross-linked by irradiating with gamma rays or electron beams.

Further advantageous embodiments of the invention can be seen from the further dependent claims.

### BRIEF DESCRIPTION OF THE DRAWINGS

The invention and further advantageous embodiments and improvements of the invention are explained and described in more detail with reference to the drawing, in which 7 exemplary embodiments of the invention are shown.

In the drawing

FIG. 1 shows a side view of a stack of arc-extinguishing plates,

FIG. 2 shows a plan view of the stack of arc-extinguishing plates according to FIG. 1,

FIG. 3 to 5 show a second exemplary embodiment of a stack of arc-extinguishing plates,

FIG. 6 shows the developed casing for the stack of arc-extinguishing plates according to FIG. 3 to 5,

FIGS. 7 and 8 show a rear and side view of a third exemplary embodiment of a stack of arc-extinguishing plates,

FIG. 9 shows the development of the cladding or casing of the stack of arc-extinguishing plates according to FIGS. 7 and 8,

FIG. 10 shows a side view of a fourth exemplary embodiment of a stack of arc-extinguishing plates,

FIG. 11 shows a development of the casing of the plate stack according to FIG. 10,

FIG. 12 shows a side view of a fifth exemplary embodiment of a stack of arc-extinguishing plates,

FIG. 13 shows a development of the casing of the stack of arc-extinguishing plates according to FIG. 12,

FIGS. 14 and 15 show a side view and plan view of a sixth or seventh exemplary embodiment of a stack of arc-extinguishing plates,

FIG. 16 shows a development of the cladding of the stack of arc-extinguishing plates according to FIGS. 14 and 15, and

FIG. 17 shows a development of a partial casing for a seventh exemplary embodiment of a stack of arc-extinguishing plates.

### DETAILED DESCRIPTION

How an arc-extinguishing stack is fitted into a line-protection circuit breaker or motor protection circuit breaker is disclosed. It is also disclosed that the stack of arc-extinguishing plates is constructed in a particular manner.

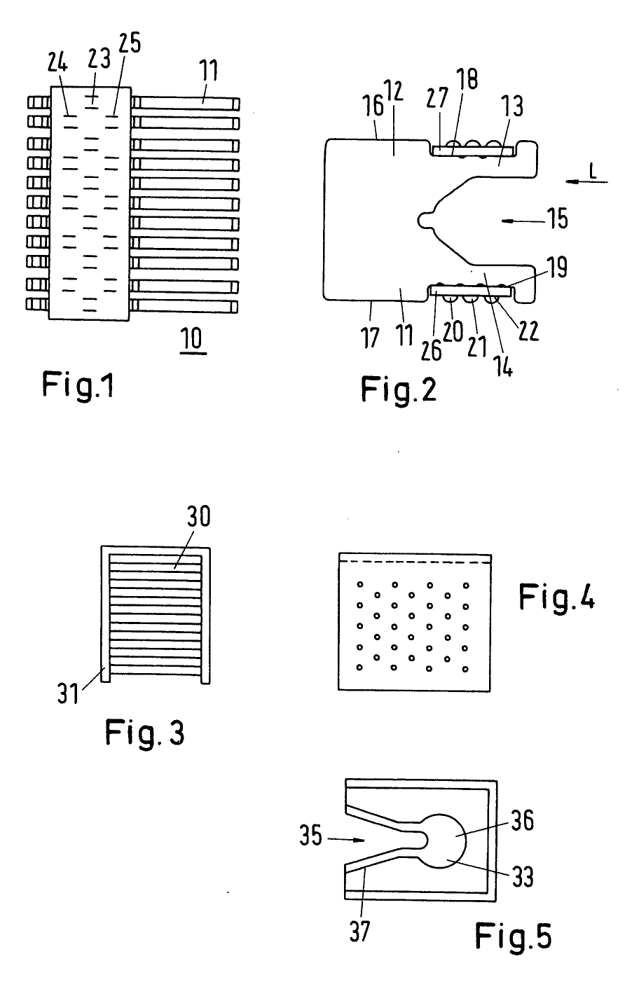

FIGS. 1 and 2 show a stack of arc-extinguishing plates 10 with a total of 11 extinguishing plates of which only the extinguishing plate 11 has been allocated the reference number. As can be seen from FIG. 2, each extinguishing plate has a rectangular shape with a plate 12 and two projecting arms 13 and 14, which form a V-shaped slot 15 between them. This slot 15 can be formed in different ways, as can be seen from FIG. 5 for example. The arc enters the slot according to the direction of the arrow L, is divided into a number of partial arcs corresponding to the number of extinguishing plates 11 in the stack of arc-extinguishing plates 10, as a result of which, as mentioned in the introduction, the arc voltage and therefore the current limitation is increased and improved. In the vicinity of the slot, each extinguishing plate 11 has a recess 18, 19 on both sides, on the base of which are moulded lugs 20, 21, 22, which are pressed into holes 23, 24, 25 of holding strips 26 and 27 arranged on both sides. As a result, the lugs 20, 21 and 22 project beyond the outer surface of the holding strips 26, 27.

According to the disclosure, these holding strips are made from thermoplastic with radiation cross-linking; it is the simplest embodiment in which particle board strips have also been used in the prior art.

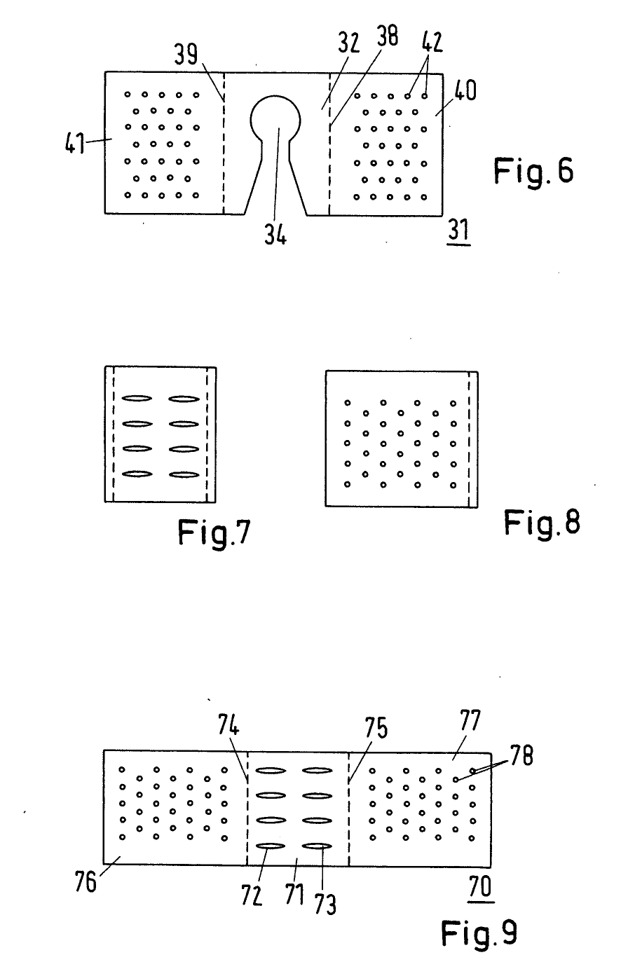

FIG. 3 shows a stack of arc-extinguishing plates 30, which is provided with a casing 31, said casing being shown in developed form in FIG. 6. The casing has a central area 32, which is matched to the peripheral edges of the plates 33, this section 32 having a recess 34, which encompasses the slot 35 of the plates 33; at the same time, the recess 34 has a circular extension 36, to which are connected approximately V-shaped extensions 37, which run parallel to the inner edges of the slot 35. As stated, the slot 34 is matched to the slot 35; in the embodiment of FIGS. 1 and 2, the slot 34 would be matched to the slot 15 of the extinguishing plate 11.

The central area 32 or central section is connected to a holding section 40, 41 in each case at the point where the longitudinal edges of the arc-extinguishing plate 33 run, by means of a film hinge 38, 39 respectively, holes 42 in which lugs (not shown) engage in a similar way to the extinguishing plate 11 in FIG. 4 to 6, being provided in said holding sections so that the holding sections 40, 41 are fixed to the stack of extinguishing plates 30, and the individual extinguishing plates are held spaced apart from one another. The casing 31 is made of thermoplastic, which is radiation cross-linked after assembly.

In the embodiment according to FIG. 7 to 9, a casing 70 (shown in developed form in FIG. 9) is provided, which has a central section 71, the peripheral contours of which correspond to the rear part of the stack of arc-extinguishing plates. The central section 71 has exhausted air openings or slots 72, 73 and serves to cover the rear side of the stack of arc-extinguishing plates. Holding sections 76, 77, which correspond to the holding sections 40, 41, are moulded on by means of film hinges 74, 75 arranged on both sides. These also have holes 78 in which corresponding lugs on the extinguishing plates engage.

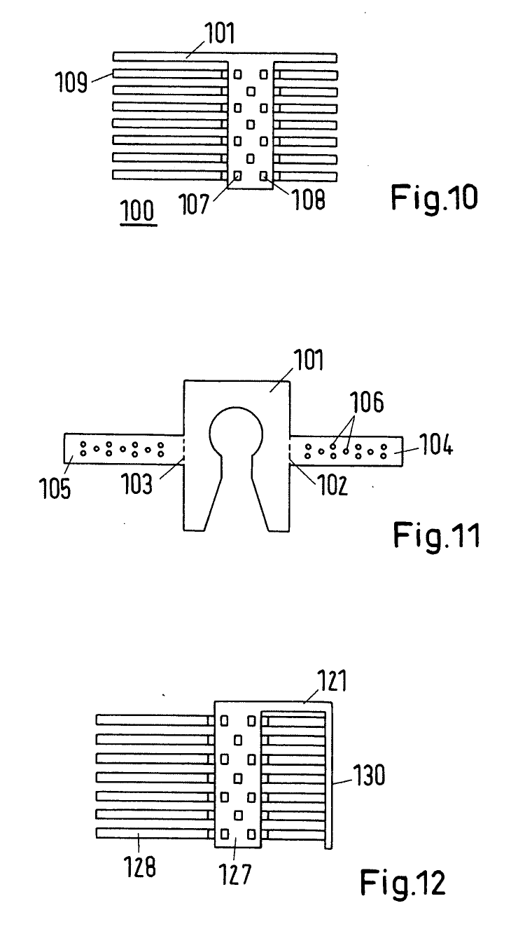

FIG. 10 shows a side view and FIG. 11 shows the developed casing for a stack of arc-extinguishing plates 100 with a central plate 101, which corresponds to the central area 32 of the embodiment according to FIG. 3. Holding sections 104, 105, which correspond to the holding elements or holding strips 26, 27 and which are provided with holes 106 so that they can be connected to the lugs 107, 108 on the extinguishing plates, are each connected to the central plate 101 by means of a film hinge 102, 103.

The extinguishing plates 109 are fixed by means of the holding sections 104 and 105; the plate 101 is arranged at a distance from the top extinguishing plate 109, which corresponds to the distance of the individual arc-extinguishing plates from one another.

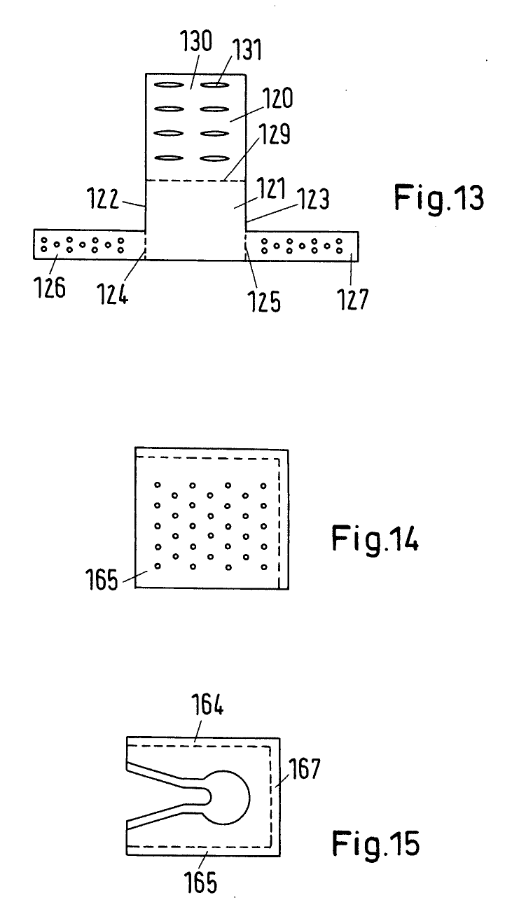

In the exemplary embodiment according to FIGS. 12 and 13, a cover 120 is provided, which has a central section 121 to which holding strips 126 and 127 corresponding to the holding strips 104 and 105 are moulded on to two parallel edges 122, 123 by means of film hinges 124, 125, said holding strips 126 and 127, as can be seen from FIG. 12, being arranged on the side edges of the extinguishing plates 128 in a similar manner to that shown in FIG. 1, FIG. 2; and FIG. 11. A cover 130 (exhaust air mask), which has slots 131, which correspond to the slots 72, 73, and which covers the rear of the stack of arc-extinguishing plates, is moulded on by means of a film hinge 129 to an edge of the plate 121, which runs perpendicular to the two edges 122 and 123.

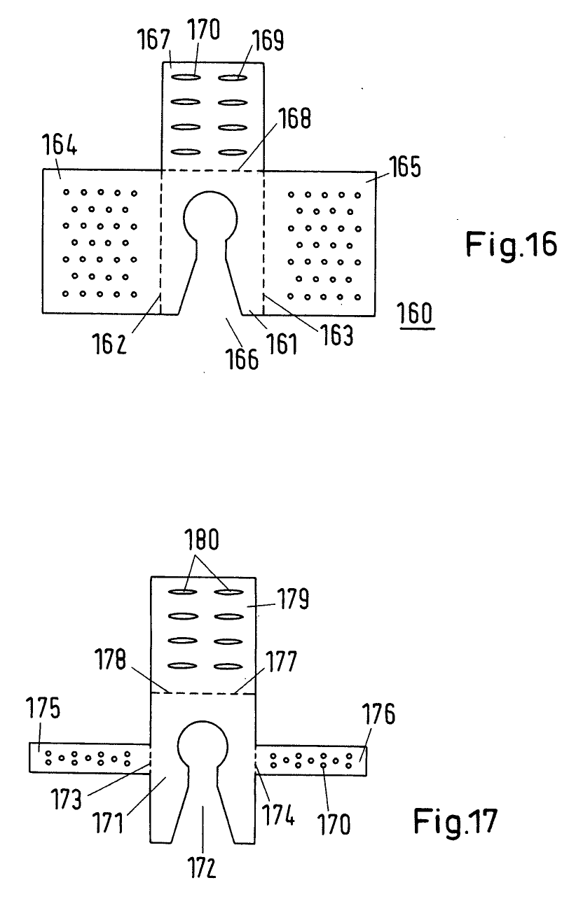

FIG. 16 shows a further exemplary embodiment of a casing in the developed state. This casing 160 has a central section 161, which corresponds to the section 101 of FIG. 11. Holding sections 164 and 165, which correspond to the holding sections 40, 41, are moulded on to the two longitudinal side edges 162, 163 by means of a film hinge in each case.

A cover section 167 is moulded on to the edge of the cover plate 161 opposite the slot 166 by means of a film hinge 168. As can be seen from FIGS. 14 and 15, the holding sections 164 and 165 are located on both sides of the stack of extinguishing plates, the rear cover section 167 covering the rear side of the stack of arc-extinguishing plates. The cover section 167 is provided with slots 169, 170 like the cover section 130 of FIG. 13 or 71 of FIG. 9.

FIG. 17 shows a further exemplary embodiment of a casing, likewise in the developed state. The casing 170 has a central section 171, which has a slot 172 and in this respect corresponds to the section 101, 161. Holding elements 175 and 176, which correspond to the holding strips 104, 105 and the holding strips 26, 27, are moulded on by means of film hinges 173 and 174 to the side edges, which run in the direction of travel of the arc. A film hinge 178, by means of which a cover section 179 containing the slot 180 is connected, is connected to the rear-facing edge 177, which runs perpendicular to the two longitudinal edges. This cover section corresponds to the cover section 167 of FIG. 16 or 130 of FIG. 13.

When all these casings are assembled, that is to say fixed to the stack of extinguishing plates, so that the extinguishing plates are also held to one another, then the thermoplastic plastic is subjected to radiation cross-linking as mentioned in the introduction.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Electrical switch, in particular line-protection circuit breaker or motor protection circuit breaker, with at least one contact point at which an arc occurs during a switching operation, and having a stack of arc-extinguishing plates made up of several extinguishing plates, the extinguishing plates of said stack being held together with a spacing by means of holding elements, wherein the holding elements are made from a thermoplastic, the subsequent assembly of which is radiation cross-linked.

2. Electrical switch having a cover provided with slots on the rear side of the stack of arc-extinguishing plates, wherein the cover is made from thermoplastic, which is radiation cross-linked after assembly.

3. Electrical switch according to claim 2, wherein the cover and the holding elements are made in one piece from thermoplastic, which is radiation cross-linked after assembly.

4. Electrical switch according to claim 1, wherein the holding elements are constructed as holding strips, which are made of thermoplastic, which is radiation cross-linked after assembly.

5. Switch according to claim 1, wherein a casing having a central section with a recess, which corresponds to and encompasses the slot of an arc-extinguishing plate, is provided, to which holding elements and/or a cover for the rear part of the arc-extinguishing plate is moulded on by means of film hinges, said casing being made from a thermoplastic, which is radiation cross-linked after assembly.

6. Electrical switch according to claim 1, wherein a radiation crosslinking booster is additionally mixed with the thermoplastic.

7. Electrical switch according to one claim 3, wherein the holding elements are constructed as holding strips, which are made of thermoplastic, which is radiation cross-linked after assembly.

8. Switch according to claim 3, wherein a casing having a central section with a recess, which corresponds to and encompasses the slot of an arc-extinguishing plate, is provided, to which holding elements and/or a cover for the rear part of the arc-extinguishing plate is moulded on by means of film hinges, said casing being made from a thermoplastic, which is radiation cross-linked after assembly.

9. Electrical switch according to claim 3, wherein a radiation cross-linking booster is additionally mixed with the thermoplastic.
